(19) United States
(12) Patent Application Publication
(10) Pub. No.: US 2025/0241333 A1
(43) Pub. Date: Jul. 31, 2025

(54) Cocoa Alkalization Processes

(71) Applicant: Olam International Limited, Singapore (SG)

(72) Inventors: Harsh Patel, Amsterdam (NL); Dirk Van Der Lee, Schijndel (NL); Francisco José Garavello, Almere (NL); Irene Cornelia ter Laak, Alphen aan den Rijn (NL)

(21) Appl. No.: 19/036,910

(22) Filed: Jan. 24, 2025

Related U.S. Application Data
(60) Provisional application No. 63/625,053, filed on Jan. 25, 2024.

(51) Int. Cl. A23G 1/02; A23G 1/00

(52) U.S. Cl. CPC A23G 1/02; A23G 1/0016

(57) ABSTRACT

Some aspects of the disclosure relate to multi-stage processes for preparing an alkalized cocoa material. In some examples, the process includes mixing cocoa and alkalization agents together, and mixing/heating until reaching an elevated mixing temperature. The process may include mixing these components together at the elevated mixing temperature for at least one hold period to provide a mixture, then aerating the mixture. The process may include an additional treatment or treatments at a held elevated temperature. The process may then include drying the mixture to provide an alkalized cocoa material.

### CROSS-REFERENCE TO RELATED APPLICATION

The present application claims the benefit of U.S. Provisional Patent Application No. 63/625,053, filed Jan. 25, 2024, which is hereby incorporated by reference in its entirety.

### TECHNICAL FIELD

In some aspects, this disclosure relates to processes for preparing an alkalized cocoa material. In some examples, the process includes mixing cocoa and a first alkalization agent together at an initial temperature and adding heat until a first elevated mixing temperature is reached, then adding a second alkalization agent, and mixing and heating the cocoa until reaching a second elevated mixing temperature. Water be added with one or both of the alkalizing agents, or in some examples, alkalizing agents are added and water is later added at a first elevated temperature. The process may include mixing these components together at the second elevated mixing temperature for at least one hold period to provide a mixture, where conditions may change between any hold periods when there are multiple such periods (e.g. a lower temperature and/or pressure is reached between period), and the process may include then drying the mixture after any hold period(s) to provide an alkalized cocoa material.

### BACKGROUND

Cocoa material may be alkalized, resulting in a change in appearance or flavor. New processes of alkalization may result in beneficial product characteristics. Thus, new processes for preparing alkalized cocoa material may be beneficial.

### SUMMARY

This Summary provides an introduction to some general concepts relating to this disclosure in a simplified form, where the general concepts are further described below in the Detailed Description. This Summary is not intended to identify key features or essential features of the disclosure.

In some aspects, this disclosure relates to processes of, inter alia, preparing an alkalized cocoa material. In some examples, the disclosure relates to the process including the step of mixing cocoa and a first alkalization agent together at an initial temperature, such as ambient temperature or typical room temperature. The process may then include mixing and heating the cocoa and the first alkalization agent until reaching a first elevated mixing temperature (e.g. about 70-150 degrees Celsius). The process may include adding a second alkalization agent to the cocoa and the first alkalization agent. Then, the process may include mixing and heating the cocoa, the first alkalization agent, and the second alkalization agent until reaching a second elevated mixing temperature (e.g. about 80-160 degrees Celsius). In some examples the process may include mixing the cocoa, the first alkalization agent, and the second alkalization agent at the second elevated mixing temperature for at least one hold period to provide a mixture (e.g. one hold period, or between about one and ten or between about one and five hold periods). In some examples, the process may include aerating the mixture and drying the mixture to provide an alkalized cocoa material.

In some examples of the process, the first elevated mixing temperature may be about 75-175 degrees Celsius. In certain examples of the process, the second elevated mixing temperature may be about 85-200 degrees Celsius. In various examples of the process, the first alkalization agent and the second alkalization agent each include or consist of one or more hydroxide materials, one or more bicarbonate materials, one or more carbonate materials, or combinations thereof. In some examples, the first alkalization agent and the second alkalization agent each include or consist of magnesium hydroxide, sodium hydroxide, calcium hydroxide, sodium carbonate, potassium carbonate, ammonium carbonate, calcium carbonate, or combinations thereof. In certain examples, the first alkalization agent and the second alkalization agent may be different materials.

In some examples, the mixing may include agitating the materials being mixed, chopping the materials being mixed, or both. Any agitation (with one or more mechanical operators, e.g. one or more plows and/or one or more scrapers and/or one or more stirrers) may be performed at a speed of about 50-170 revolutions per minute, e.g. about 100-125 rpm. Any chopping (with one or more mechanical operators, e.g. one or more blades) may be at a speed of about 750-5000 revolutions per minute, e.g. about 1000-3500, or about 3000-3500.

In some examples of the process, any hold periods of the at least one hold period may be about 30 minutes or more in length, or about 45 minutes or more in length, or about 60 minutes or more in length, or about 75 minutes or more in length, or about 90 minutes or more in length, or about 120 minutes or more in length, or about 180 minutes or more in length, or about 240 minutes or more in length, or about 300 minutes or more in length. In some examples, the at least one hold period may total a single hold period, while in some examples the at least one hold period may total two or more hold periods (e.g. two hold periods, three hold periods, four hold periods, five hold periods, six hold periods, seven hold periods, or eight hold periods). In some examples, the cocoa, the first alkalization agent, and the second alkalization agent may be cooled between any hold periods.

In certain examples, the cocoa, the first alkalization agent, and the second alkalization agent may be subjected to a pressure during the at least one hold period. If there are multiple hold periods, at least one hold period may be at ambient pressure and at least one additional hold period may be at a non-ambient pressure, while in some examples all hold periods are at a relatively high pressure and any intermediate processing is at ambient pressure or a lower pressure than during the hold period. In some examples the cocoa, the first alkalization agent, and the second alkalization agent are subjected to a pressure of about 1-10 bars during the at least one hold period, or during at least one of the hold periods. In some examples, the pressure may be generated by the addition of heated air, steam, or a combination thereof.

In some examples, the obtained, alkalized mixture may be dried, for example by air drying, hot air drying, vacuum drying, or combinations thereof. In some examples of the process, the process may include adding water to at least the cocoa, and then mixing the water and at least the cocoa. In some examples of the process, the process may include adding compressed air to the cocoa, the first alkalization agent, and the second alkalization agent after at least one hold period to lower the temperature of the mixture.

In some examples, the alkalized cocoa material prepared by an example process may include a moisture content of about 1-20%, by weight. In certain examples, the cocoa may include or entirely consist of cocoa cake. In certain examples, the cocoa may have a moisture content of 1-20%, by weight, before alkalization.

In certain examples, processes for forming an alkalized cocoa material such as a cocoa powder are provided, including dark cocoa powder. These processes may include any of the steps, conditions, or equipment described above and/or in processes for preparing other cocoa products (and vice versa). In certain examples, a process for forming alkalized cocoa material includes the steps of mixing cocoa cake and a first alkalization agent together at an initial temperature. The process may include mixing and heating the cocoa cake and the first alkalization agent until reaching a first elevated mixing temperature. The process may include adding a second alkalization agent to the cocoa cake and the first alkalization agent. The process may include mixing and heating the cocoa cake, the first alkalization agent, and the second alkalization agent until reaching a second elevated mixing temperature.

In some examples, the process may include mixing the cocoa, the first alkalization agent, and the second alkalization agent at the second elevated mixing temperature for at an initial hold period to provide a mixture, and then aerating (ambiently or under pressure) and cooling the mixture. In certain examples, the process may include heating the mixture to a third elevated mixing temperature (which can be the same, or different, from the second elevated temperature) and mixing for at least one additional hold period. In some examples, the process may include drying the mixture to provide an alkalized cocoa material, such as an alkalized dark cocoa material.

In certain examples, all of the elevated mixing temperatures may be about 75-150 degrees Celsius. In some examples, any hold periods (initial or additional) may be about 30-150 minutes in length. In certain examples, the mixture is cooled between any of the at least one additional hold periods (e.g. back to about 100 degrees Celsius, or about ambient temperature). In certain examples, water is added to at least the cocoa cake and mixed with at least the cocoa cake prior to the initial hold period (whether to the cake, or to the cake and at least some other material like one or two alkalizing agents).

In certain examples of the process, the first alkalization agent and the second alkalization agent each include or consist of one or more hydroxide materials, one or more bicarbonate materials, one or more carbonate materials, or combinations thereof. In some examples, the first alkalization agent and the second alkalization agent each include or consist of magnesium hydroxide, sodium hydroxide, calcium hydroxide, sodium carbonate, potassium carbonate, ammonium carbonate, calcium carbonate, or combinations thereof. In some examples, the first alkalization agent and the second alkalization agent are different materials. In various embodiments, the first alkalization agent and the second alkalization agent each include or consist of sodium hydroxide or ammonium carbonate (e.g. one is sodium hydroxide and the other is ammonium carbonate).

In certain examples, any mixing includes agitating the materials being mixed, chopping the materials being mixed, or both. In some examples, any agitation is at a speed of about 50-170 revolutions per minute, and wherein any chopping is at a speed of about 1000-3500 revolutions per minute.

In some examples of the process, the at least one additional hold period includes at least two additional hold periods, and the mixture is cooled and aerated between the additional hold periods. In certain examples, the at least one additional hold period includes at least three additional hold periods, and the mixture is cooled and aerated between the additional hold periods.

In some examples of the process, the cocoa, the first alkalization agent, and the second alkalization agent are subjected to an elevated pressure during the initial hold period and the at least one additional hold period (e.g. about 2-8 bar, or about 4-6 bar, or about 4-8 bar). In some examples, the cocoa, the first alkalization agent, and the second alkalization agent are subjected to an elevated pressure of up to about 8 bars during the initial hold period and the at least one additional hold period. In certain examples, the pressure is generated by the addition of heated air, steam, or a combination thereof. In some examples, the mixture is dried by air drying, hot air drying, vacuum drying, or combinations thereof.

In some examples of the process, the process further includes adding compressed air to the cocoa, the first alkalization agent, and the second alkalization agent after the at least one additional hold period to lower the temperature of the mixture. In certain examples, the alkalized cocoa material includes a moisture content of about 1-20%, by weight. In some examples of the process, any aeration is performed at an ambient pressure. In certain examples of the process, any aeration is performed at an elevated pressure.

In some examples, a process for forming an alkalized cocoa material is provided including the step of mixing and heating cocoa cake, a first alkalization agent, a second alkalization agent and water at a first elevated mixing temperature for at an initial hold period to provide a mixture, and then aerating and cooling the mixture. In certain examples, the process then includes heating the mixture to a second elevated mixing temperature and mixing for at least one additional hold period, and then drying the mixture to provide an alkalized cocoa material. In some examples, all of the elevated mixing temperatures are about 75-150 degrees Celsius. In some examples, any hold periods are about 10-150 minutes in length, and the mixture is aerated and/or cooled between any of the at least one additional hold periods. In certain examples, at least some aeration, or any aeration, is performed at an elevated pressure.

In some examples, a multi-stage process for forming an alkalized cocoa cake material includes mixing cocoa cake and a first alkalization agent together at an initial temperature, the cocoa cake comprising a fat content of 8-24%, by weight, and a moisture content of 1-7%, by weight, mixing and heating the cocoa cake and the first alkalization agent until reaching a first elevated mixing temperature, adding a second alkalization agent to the cocoa cake and the first alkalization agent, mixing and heating the cocoa cake, the first alkalization agent, and the second alkalization agent through the applications of external heat until reaching a second elevated mixing temperature, mixing the cocoa, the first alkalization agent, and the second alkalization agent at the second elevated mixing temperature for at an initial hold period to provide a mixture, aerating and cooling the mixture, heating the mixture to a third elevated mixing temperature and mixing for at least one additional hold period and drying the mixture to provide an alkalized cocoa material, where all of the elevated mixing temperatures are 75-150 degrees Celsius, where any hold periods are 10-150 minutes in length, and where a total residence time of the hold periods is 100-350 minutes, and where the mixture is aerated and cooled between any of the at least one additional hold periods; and where water is added to at least the cocoa cake and mixed with at least the cocoa cake prior to the initial hold period.

In some examples, a multi-stage process for forming an alkalized cocoa material includes mixing and heating cocoa cake, a first alkalization agent, a second alkalization agent and water at a first elevated mixing temperature for at an initial hold period to provide a mixture, aerating the mixture, heating the mixture to a second elevated mixing temperature through the applications of external heat and mixing for at least one additional hold period, and drying the mixture to provide an alkalized cocoa material, where all of the elevated mixing temperatures are 75-150 degrees Celsius, where the cocoa cake, the first alkalization agent, and the second alkalization agent are subjected to an elevated pressure above 2 bars during the initial hold period and the at least one additional hold period, and where any hold periods are 10-150 minutes in length, and where a total residence time of the hold periods is 100-350 minutes and where the mixture is aerated between any of the at least one additional hold periods.

In another aspect of the disclosure, edible compositions such as cookies or other desserts are provided. Example edible compositions include cookies, cakes, breads, beverages, ice cream, pies, or truffles. In some examples, an edible composition includes an alkalized cocoa material made from a process of this disclosure. In other examples, an edible composition includes two or more alkalized cocoa materials, each made from distinct processes of this disclosure.

These and other features, advantages, and objects of the present disclosure will be further understood and appreciated by those skilled in the art by reference to the following specification and claims.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures. A more complete understanding of the present disclosure and the advantages thereof may be acquired by referring to the following description in consideration of the accompanying drawings, which show example process steps and/or information, including:

FIG. 1 shows a graph illustrating example temperature and time variations across an example process using multiple hold periods.

FIG. 2 shows a process flow chart with example steps for an example implementation of the process.

### DETAILED DESCRIPTION

The examples, materials and methods of described herein provide, inter alia, processes and systems for preparing alkalized cocoa materials. These and other aspects, features and advantages of the disclosure or of certain embodiments of the disclosure will be further understood by those skilled in the art from the following description of example embodiments. In the following description of various examples, reference is made to the accompanying drawings, which form a part hereof. It is to be understood that other modifications may be made from the specifically described methods and systems without departing from the scope of the present disclosure.

It is also to be understood that the specific materials, systems, devices and processes described in the following specification, are simply example embodiments. Hence, specific numerical values, dimensions and other characteristics relating to the embodiments disclosed herein are not to be considered as limiting.

Ranges: throughout this disclosure, various aspects of the disclosure can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range. It is understood that any and all whole or partial integers between any ranges set forth herein are included herein.

Finally, the use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those skilled in this art without departing from the spirit and scope of the disclosure.

In some aspects, this disclosure relates to processes of, inter alia, preparing an alkalized cocoa material. As illustrated below, the processes can shorten the extended reaction times required by traditional alkalization processes and/or reduce the considerable quantities of alkalizing agents thought to have been required to achieve such dark colors, thus providing more efficient processes that can provide benefits of alkalization while also preserving the inherent properties and flavor of the resulting cocoa by that can be damages by extensive/extreme processing. For example, the cyclical nature of multi-hold processes enhances air replenishment, resulting in improved oxidation and accelerated reactions, ultimately streamlining production while maintaining or even improving the cocoa powder product characteristics. What's more, in processes that involve pressurized aeration, highly dark and flavorful materials can be obtained with reduced levels of alkalizing agents (including under 7% and even under 4%), by optimizing air exchange and enhancing oxidation and accelerating reaction rate. The processes of this disclosure thus provide advantages in processing speed, costs, product characteristics, and environmental and health considerations (e.g. by lowering the amount of alkali need to obtain highly alkalized materials). In certain examples, the process relates to preparing an alkalized cocoa material, such as dark, alkalized cocoa cake. The cocoa material to be alkalized may be cocoa beans, cocoa nibs, cocoa cake, cocoa powder, cocoa liquor, or any other cocoa material, e.g. a combination of any cocoa source(s) that contain cocoa solids. The cocoa material may or may not have already been reacted with one or more alkalizing agents before undergoing additional alkalization process(es) as described herein.

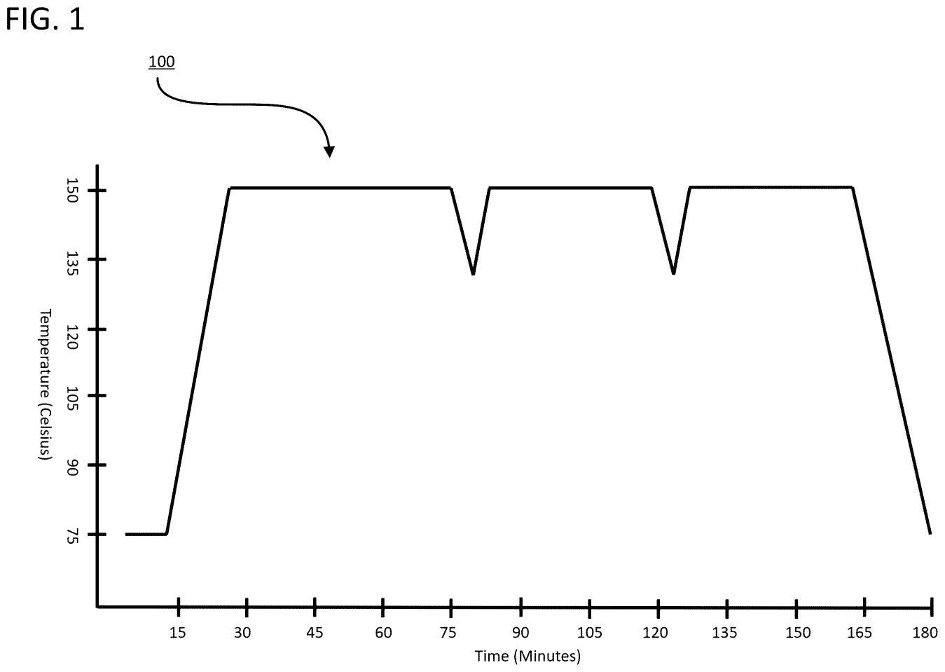

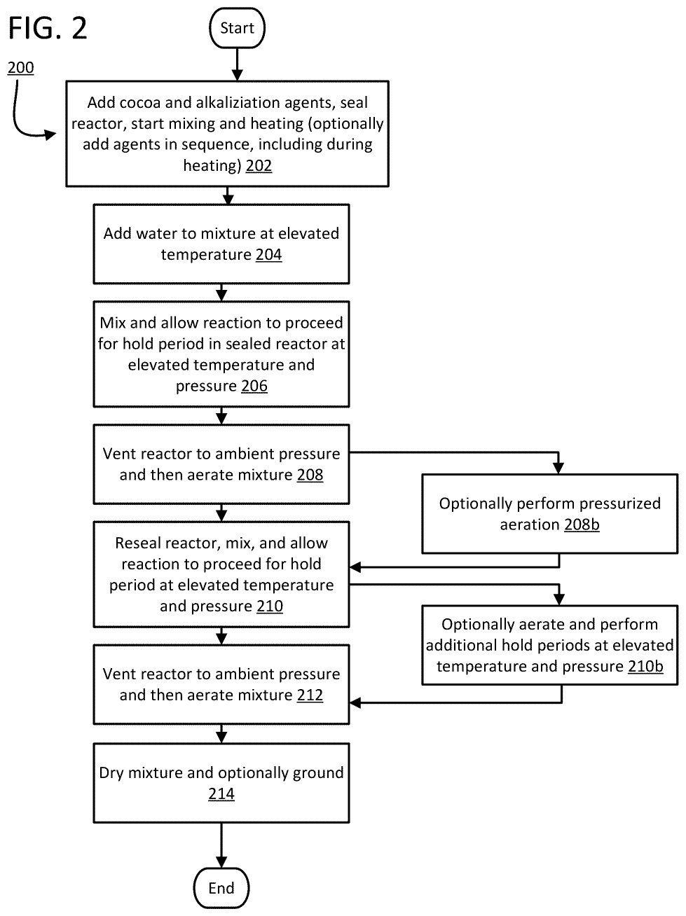

The Figures provide illustrations of concepts described in more detail below. For example, FIG. 1 shows an example temperature profile 100 of an alkalization process over time (scaling is exemplary), where in an initial plateau components may be combined (e.g. cocoa material and alkalizing agent) and then during mixing the temperature starts to increase, where another alkalizing agent may be added at this time, or in the initial plateau. The materials are then mixed and held at an elevated temperature for a hold period, before conditions are relaxed (e.g. the reactor is opened, materials are cooled, air is replenished, and the like) before another period of being held under elevated reaction period occurs. In this example, there are three total hold periods at an elevated temperature (all equal here, but this is not always the case) with transition periods of relatively lower temperatures, followed by a final cooldown period. FIG. 2 provides a process flow diagram of an example process 200 with example steps 202-214, including optional steps, e.g. step 208b. Various implementations of these steps are described in more detail below. Reactors suitable for performing example processes may be configured to provide a homogenous or essentially homogenous mixture of solids materials, capable of reducing particle sizes (e.g. reducing the particle size of cocoa cake), proper dispersion of solids when water is added, and provision of uninform or essentially uniform heating without “cold spots” and/or material accumulation in a particular location of the reactor. For example, a plow mixers with a jacket capable of heating/cooling the drum may be used.

In some examples, the disclosure relates to the process including the step of mixing cocoa and a first alkalization agent together at an initial temperature, e.g. an ambient temperature or an elevated temperature above an ambient temperature (temperatures, unless specified for equipment, such as a reactor jacket, are for the materials being treated, e.g. the cocoa material). The process may then include mixing and heating the cocoa (e.g. by adding steam to the jacket of a reactor chamber) and the first alkalization agent until reaching a first elevated mixing temperature.

The first elevated temperature may be, for example, about 90-150 degrees Celsius, about 75-175 degrees Celsius, about 50-100 degrees Celsius, about 75-100 degrees Celsius, about 75-150 degrees Celsius, about 130-145 degrees Celsius, about 100-200 degrees Celsius, about 100-160 degrees Celsius, about 125-150 degrees Celsius, or about 125-200 degrees Celsius. The first elevated temperature may be, for example, about 200 degrees Celsius or less, or about 175 degrees Celsius or less, or about 150 degrees or less, or about 125 degrees Celsius or less, or about 100 degrees or less, or about 90 degrees Celsius or less, or about 75 degrees Celsius or less. The first elevated temperature may be, for example, about 75 degrees Celsius or more, or about 85 degrees Celsius or more, or about 90 degrees Celsius or more, or about 100 degrees Celsius or more, or about 125 degrees Celsius or more, or about 150 degrees Celsius or more, or about 175 degrees Celsius or more. The first elevated temperature may be, for example, about 75 degrees Celsius, about 80 degrees Celsius, about 90 degrees Celsius, about 100 degrees Celsius, about 110 degrees Celsius, about 120 degrees Celsius, about 130 degrees Celsius, about 140 degrees Celsius, about 150 degrees Celsius, about 160 degrees Celsius, about 170 degrees Celsius, or about 180 degrees Celsius.

The process may include adding a second alkalization agent to the cocoa and the first alkalization agent (or, in some examples, both alkalization agents are added at an initial temperature and water is added at the first elevated temperature). Once the reactor is sealed and heating is underway, additional components like a second alkalization agent or water may be added through a port, or by otherwise reopening the reactor briefly. Then, the process may include mixing and heating the cocoa, the first alkalization agent, and the second alkalization agent until reaching a second elevated mixing temperature (e.g. about 80-160 degrees Celsius) where the materials may be held for a hold period to allow the reaction to proceed. The second elevated temperature may be higher than the first elevated temperature, or equal, or less (if still above ambient temperature, wherein ambient temperatures are generally considered to be within the range of 20-25° C.). In certain examples of the process, the second elevated mixing temperature may be about 85-200 degrees Celsius, about 75-175 degrees Celsius, about 50-200 degrees Celsius, about 100-250 degrees Celsius, about 75-120 degrees Celsius, about 90-200 degrees Celsius, or about 125-200 degrees Celsius. For any elevated temperatures, heat/steam may be used to heat the reactor jacket to a higher temperature until the mixture reaches the desired temperature (e.g. a jacket temperature of 135 degrees is used until a desired mixture temperature of 110 degrees is reached), or other methods of heating application may be used instead or in conjunction with heat/steam jacket application, such as oil and/or electrical heating instead of and/or in addition to steam.

The second elevated temperature may be, for example, about 200 degrees Celsius or less, or about 175 degrees or less, or about 150 degrees Celsius or less, or about 125 degrees or less, or about 100 degrees Celsius or less, or about 85 degrees Celsius or less. The second elevated temperature may be, for example, about 85 degrees Celsius or more, or about 95 degrees Celsius or more, or about 100 degrees Celsius or more, or about 120 degrees Celsius or more, or about 130 degrees Celsius or more, or about 150 degrees Celsius or more, or about 175 degrees Celsius or more. The second elevated temperature may be, for example, about 95 degrees Celsius, about 105 degrees Celsius, about 110 degrees Celsius, about 120 degrees Celsius, about 130 degrees Celsius, about 140 degrees Celsius, about 150 degrees Celsius, about 160 degrees Celsius, about 170 degrees Celsius, about 180 degrees Celsius, about 190 degrees Celsius, or about 200 degrees Celsius. In examples with additional hold periods, subsequent elevated temperatures, e.g. a third elevated temperature, may use any of these values/ranges. Subsequent elevated temperatures may be different from the second elevated temperature and/or each other, or the same as the second elevated temperature and/or each other.

In certain examples of the process, any alkalizing agents are added together to the initial cocoa material being alkalized, e.g. cocoa nibs or cocoa cake, for example before any temperature ramp-up. In some examples, any alkalizing agents are added together to the initial cocoa material being alkalized and then mixed until reaching a first elevated temperature, and then water is added at the first elevated temperature. In some embodiments, water and a first alkalizing agent are added to cocoa, and then mixing/temperature ramp up occur and second alkalizing agent is added at a first elevated temperature. Any of the procedures, steps, and values described herein may be used for either method examples, e.g. regardless of whether the addition of water may be timed to occur initially or at a first elevated temperature, and/or whether any additional alkalizing agents (if used) may be added to a first alkalizing agent initially or at a later time such as the first elevated temperature, any described values for temperature, pressure, hold periods, etc. may be used.

In some examples the process may include mixing the cocoa, the first alkalization agent, and the second alkalization agent at the second elevated mixing temperature for at least one hold period to provide a mixture. In some examples, the at least one hold period may total a single hold period, while in some examples the at least one hold period may total two or more hold periods (e.g. two hold periods, three hold periods, four hold periods, five hold periods, six hold periods, seven hold periods, or eight hold periods). In some examples, there may be only one hold period for mixing at temperature. In certain examples, there may be two hold periods or more, three hold periods or more, four hold periods or more, five hold periods or more, six hold periods or more, or seven hold periods of more. In hold period(s), the temperature and/or pressure, and often both, may be elevated compared ambient conditions and held constant or relatively constant for an extended period of continued agitation to facilitate the cocoa alkalization reaction and processing.

The temperature and/or pressure may be lowered in between hold periods, e.g. through ambient heat loss or intentional efforts for example by opening a chamber containing the materials/depressurizing and/or adding air, such that in some examples, the cocoa, the first alkalization agent, and the second alkalization agent may be cooled between any hold periods and/or after a hold period, for example through a cycling between the hold period temperature and a lower temperature than the second elevated temperature (e.g. a temperature at, above, or below the first elevated temperature), e.g. via heat loss to ambient air upon opening of the heated reactor and/or via blown air. In some examples, there may be between about one and ten hold periods, between about five and ten hold periods, or between about one and five hold periods, or between about three and five hold periods, or between about six and eight hold periods. In some examples, there may be one hold period for mixing at temperature, or two, or three, or four, or five, or six, or seven hold periods.

In some examples of the process, any hold periods of the at least one hold period may be about 10 minutes or more in length, 20 minutes or more in length, 25 minutes or more in length, 30 minutes or more in length, or about 45 minutes or more in length, or about 60 minutes or more in length, or about 75 minutes or more in length, or about 90 minutes or more in length, or about 120 minutes or more in length, or about 150 minutes or more in length, or about 180 minutes or more in length, or about 240 minutes or more in length, or about 300 minutes or more in length. In some examples, a total residence time at an elevated temperature (e.g. total length of the hold periods in the process, such as the total time including the second elevated temperature, when multiple elevated temperatures are used) may be about 50 minutes or more, or about 100 minutes or more, or about 150 minutes or more, or about 200 minutes or more, or about 250 minutes or more. In some examples, a total residence time at the second elevated temperature may be about 400 minutes or less, 250 minutes or less, or about 200 minutes or less, or about 150 minutes or less, or about 125 minutes or less, or about 100 minutes or less. In some examples, an initial hold period is used, then a transition period occurs (e.g. opening a reactor/venting, cooling the mixed materials through blown air) before subjecting the mixture to an additional hold period at an elevated temperature and/or pressure. This may replenish the air and oxygen in the reactor prior to additional processing in a subsequent hold period. In some examples, an initial hold period is used, then a transition period occurs (e.g. opening a reactor/venting, cooling the mixed materials through blown air, and providing air replenishment) before subjecting the mixture to an additional hold period at an elevated temperature and pressure, followed by an additional sequence or sequences of a transition period and another hold period. This multi-stage, repeated hold period process can advantageously enhance processing time and/or lower the amount of alkali material needed by increasing oxidation and accelerating the desired reaction rate. The number of transitions/air replenishments may be about 1-8 times, about 2-5 times, about 1-5 times, or about 3-8 times, or 1 or more times, or 2 or more times, or 3 or more times, or 4 or more times, or 5 or more times, followed by an appropriate amount of hold periods.

In some examples, a total residence time at an elevated temperature (e.g. the second elevated temperature) during hold periods may be about 50-300 minutes, or about 100-250 minutes, or about 100-350 minutes, or about 50-250 minutes, or about 150-250 minutes, or about 50-125 minutes. In some examples, the same total residence times may include any temperature ramp up periods (including but not limited to the first elevated temperature) while in others additional time will be taken by any temperature ramp-up(s) and/or the first elevated temperature and residence time is based on the hold period time only. The hold periods may have minor variations in material temperature based on heat application timing, mixing, and/or reaction process and thus may be at or around a particular temperature or temperature range, e.g. within five degrees of a target elevated temperature.

In some examples, an initial hold period is longer than any additional, subsequent hold periods, e.g. an initial hold period is about 20 minutes more than any subsequent hold periods, about 30 minutes more than any subsequent hold periods, about 40 minutes more than any subsequent hold periods, about 50 minutes more than any subsequent hold periods, or about 60 minutes more than any additional, subsequent hold periods, or is longer than at least one subsequent hold period by these or other amounts. In some examples, the initial hold period is about 30 minutes, about 45 minutes, about 60 minutes, about 75 minutes, or about 90 minutes, or about 60-90 minutes, or about 30-90 minutes, or about 90 minutes or less, or about 60 minutes or less, or about 30 minutes or more, or about 60 minutes or more. In other examples, the initial hold period is shorter than any additional, subsequent hold periods, including by the amounts discussed above. Subsequent hold periods may have shorter intervals, such as about 10 minutes, or about 20 minutes, or about 30 minutes, or about 10-45 minutes, or about 20-60 minutes, or about 10-30 minutes.

As noted above, if there are multiple hold periods, the temperature and/or pressure may be lowered in between hold periods, e.g. the pressure may return to ambient pressure or a pressure closer to ambient pressure, for example by opening or venting a reactor. Thus, there may be an intermediate temperature between any hold periods that is lower than the second elevated temperature, which may be higher than the ambient temperature, and higher, equal to, or lower than the first elevated temperature. The intermediate temperature may be, for example, about 90-170 degrees Celsius, about 75-195 degrees Celsius, about 50-120 degrees Celsius, about 75-120 degrees Celsius, about 75-160 degrees Celsius, about 100-200 degrees Celsius, or about 125-200 degrees Celsius.

The intermediate temperature may be, for example, about 200 degrees Celsius or less, or about 175 degrees Celsius or less, or about 150 degrees or less, or about 125 degrees Celsius or less, or about 100 degrees or less, or about 90 degrees Celsius or less, or about 75 degrees Celsius or less. The intermediate temperature may be, for example, about 75 degrees Celsius or more, or about 85 degrees Celsius or more, or about 90 degrees Celsius or more, or about 100 degrees Celsius or more, or about 125 degrees Celsius or more, or about 150 degrees Celsius or more, or about 175 degrees Celsius or more. The intermediate temperature may be, for example, about 75 degrees Celsius, about 80 degrees Celsius, about 90 degrees Celsius, about 100 degrees Celsius, about 110 degrees Celsius, about 120 degrees Celsius, about 130 degrees Celsius, about 140 degrees Celsius, about 150 degrees Celsius, about 160 degrees Celsius, about 170 degrees Celsius, or about 180 degrees Celsius.

In various examples of the process, the first alkalization agent and the second alkalization agent each include or consist of one or more hydroxide materials, one or more bicarbonate materials, one or more carbonate materials, or combinations thereof. In some examples, the first alkalization agent and the second alkalization agent each include or consist of magnesium hydroxide, sodium hydroxide, calcium hydroxide, sodium carbonate, potassium carbonate, ammonium carbonate or ammonium bicarbonate, calcium carbonate, or combinations thereof. In certain examples, the first alkalization agent and the second alkalization agent may be different materials, while in others they are the same material, or include the same material. For example, one agent may be calcium carbonate and/or ammonium carbonate or ammonium bicarbonate, while another may be magnesium hydroxide and/or sodium hydroxide. In examples where one or more ammonium materials are used, the process may include scrubbing and/or treatment equipment to mitigate or substantially prevent any potential emissions.

In some examples, the mixing may include agitating the materials being mixed, chopping the materials being mixed, or both. Any agitation (with one or more mechanical operators, e.g. one or more plows and/or one or more scrapers) may be performed at a speed of about 50-170 revolutions per minute, or about 70-100 revolutions per minute, or about 75-125 revolutions per minute, or about 120-170 revolutions per minute. Any chopping (with one or more mechanical operators, e.g. one or more blades) may be at a speed of about 1000-4000 revolutions per minute, or about 1500-3500 revolutions per minute, or about 1200-1800 revolutions per minute, or about 1600-1900 revolutions per minute, or about 2700-3400 revolutions per minute, or about 1000-3500 revolutions per minute, or about 2000-3500 revolutions per minute. An example reactor or chamber that may be used is a 130 L horizontal reactor including a plowshare mixer and an example chopper uses a 7.5 kW motor with a standard speed of 3480 rpm. But while up to 3500 rpm may often be used for choppers due to motor limitations, the rpm for plow mixers depends on the size of the reactor. For example, with a larger reactor (for example a 300 L horizontal reactor) a lower rpm may be used to achieve a similar tangential velocity compared to smaller reactors at higher rpm values. Speeds may be selected based on the size of the reactor to ensure sufficient tangential velocity that can provide appropriate mixing/particle size reduction. The use of choppers may improve mixing efficiency, resulting in smaller particle sizes. Choppers may also reduce lumping.

The materials being mixed may be agitated and/or chopped, e.g. inside the reactor during mixing via components in a reactor chamber. For example, the one or more agitator(s) and/or chopper(s) may be static while present in a rotating container or drum, to further facilitate mixing, or vice versa (i.e. the drum is static and one or more agitator(s) and/or chopper(s) may be in motion). The agitation and/or chopping may occur throughout the entire process, e.g. during temperature ramp up, hold period(s), and intermediate time between hold period(s), any aeration, and/or any drying.

In certain examples, the cocoa, the first alkalization agent, and the second alkalization agent may subjected to a pressure during the at least one hold period. If there are multiple hold periods, at least one hold period may be at ambient pressure and at least one additional hold period may be at a non-ambient pressure, e.g. an elevated pressure. In some examples the cocoa, the first alkalization agent, and the second alkalization agent are subjected to a pressure of about 1-10 bars (absolute, and in this disclosure all pressure values are absolute instead of gauge values unless otherwise specified, e.g. bar(a) rather than bar(g) values) during the at least one hold period, or during at least one of the hold periods, or about 1-5 bars, or about 2-4 bars, or about 2-7 bars, or about 3-6 bars, or about 3-7 bars, or about 4-7 bars, or about 4-8 bars, or about 6-7 bars, or about 6-8 bars, or about 5 bars or less, or about 10 bars or less, or about 7 bars or less, or about 3 bars or more, or about 2 bars or more, or about 5 bars or more. In some examples, the pressure of an initial hold period is between about 1-5 bar, or about 3-4 bar, or about 3-5 bar, while the pressure for any subsequent additional hold period(s) is higher, e.g. about 1-10 bar, about 2-8 bar, about 5-7 bar, or about 6-8 bars, or about 4-8 bar.

In some examples, adding heat/steam may be sufficient to reach a desired pressure by raising the temperature of the contents of the reactor, while in others, if the internal reactor pressure is lower than desired once the mixture has reached a desired temperature, the difference may be supplemented with air such as compressed air. In some examples, there may be an initial pressure value/range targeted, e.g. when all materials are added and first mixed, and then a different pressure value/range will be used during any subsequent hold periods, or may be set as a maximum pressure value (after which the system will vent, e.g. to drop about 0.5 bar in pressure) as the reaction may increase pressure as the materials react. Any of these values may be used for either set, e.g. an initial pressure of about 2-4 bars, or about 3-6 bars, or about 3-7 bars, or about 4-7 bars, or about 3 bar, or about 4 bar, or about 5 bar, or about 6 bar, is targeted in early mixing and then the hold period will either use the same pressure or a higher pressure than can occur through the reaction itself, e.g. about 3-6 bars, or about 3-7 bars, or about 4-7 bars, or about 5-8 bars, or about 4 bar, or about 5 bar, or about 6 bar, or about 7 bar, or about 8 bar.

In some examples, the pressure may be generated by the addition of heated air, steam, or a combination thereof. In some examples, any increase in temperature may be generated by the addition of heated air, steam, or a combination thereof. Steam may be applied to the exterior of a drum or jacket or other container that contains the materials being mixed/heated, and/or may be added directly into a mixing area to more directly increase temperature and pressure, e.g. steam may be added externally until reaching the first elevated temperature, then after adding of addition component(s) steam is added directly into the chamber to reach a second elevated temperature, or vice versa. If a desired temperature is reached, air such as compressed air may be used to influence pressure, e.g. raise pressure further, to e.g. about two bars or about four bars for the hold period(s). For example, steam may be added until reaching a desired temperature and/or pressure to be used in a hold period and/or to maintain a desired temperature and/or pressure in a hold period, and then not applied after the hold period (e.g. at the end of treatment or between hold periods, if multiple).

In some examples, the process may include aerating the mixture after processing at the hold period(s), for example through the addition of air, during and/or after the operation of mixing equipment. In some examples, the aeration is an ambient aeration, e.g. the reactor is opened and vented until reaching an ambient pressure, and then additional air is provided to aerate the material without subjecting it to relatively elevated pressures above ambient pressure (beyond minor changes in pressure from flowing air, e.g. about 5.1 cubic meters per hour or 10.2 cubic meters per hour of air, that can also escape the opened and vented reactor). In some examples, the aeration is a pressurized aeration, e.g. the reactor is closed and the vent valve is adjusted to maintain a pressure above ambient pressure while additional airflow is added, for example about 3.4 cubic meters per hour or about 5.1 cubic meters per hour of air is blown into the reactor and the vent valve is adjusted such that the inner pressure may be maintained during the addition of airflow at a pressure of about 4 bar, or about 5 bar, or about 6 bar, or about 7 bar, or some other pressure above ambient pressure. In some examples, an ambient aeration is performed, and then the reactor is sealed and a pressurized aeration is performed afterward. In certain examples of the process, at least some aeration is pressurized aeration. In some examples, pressurized aeration is used instead of any depressurizing between hold periods, if multiple hold periods.

For example, air may be added (in an ambient aeration, a pressurized aeration, or both) during mixing after a hold period for a period of about one minute, about two minutes, about three minutes, about four minutes, about five minutes, about six minutes, about seven minutes, about eight minutes, about ten minutes, or about fifteen minutes, or about 30 minutes, or about 45 minutes, or about 60 minutes, or about 75 minutes, or about 90 minutes. In some examples, air may be added for about fifteen minutes or less, or about ten minutes or less, or about five minutes or less, or about one minute or more, or about three minutes or more, or about five minutes or more, or about ten minutes or more, or about 10-15 minutes, or about 5-10 minutes, or about 1-3 minutes, or about 3-5 minutes, or about 5-8 minutes, or about 1-5 minutes, or about 15-30 minutes, or about 15-45 minutes, or about 45-60 minutes, or about 45-75 minutes, or about 60-75 minutes). In some examples of pressurized aerations, air is added for at about 30 minutes or more, or about 45 minutes or more, or about 60 minutes or more, or about 75 minutes or more. Air may be added for a desired aeration period, and/or for whatever time is appropriate to reach a desired intermediate temperature for the materials being mixed, e.g. about 80 degrees Celsius or about 100 degrees Celsius or about 120 degrees Celsius or about 150 degrees Celsius, rather than a defined time period.

Air may be added, e.g. after venting and/or opening the chamber containing the materials being mixed until reaching a lower temperature and/or pressure in an ambient aeration, or into a closed or partially closed reactor in a pressurized aeration, to the mixing material at a rate of about 1.7 cubic meters per hour, about 3.4 cubic meters per hour, about 5.1 cubic meters per hour, about 6.8 cubic meters per hour, about 8.5 cubic meters per hour, about 10.2 cubic meters per hour, about 13.6 cubic meters per hour, or about 17 cubic meters per hour, or about 17 cubic meters per hour or less, or about 8.5 cubic meters per hour or less, or about 5.1 cubic meters per hour or less, or about 1.7 cubic meters per hour or more, about 3.4 cubic meters per hour or more, about 5.1 cubic meters per hour or more, about 8.5 cubic meters per hour or more, or about 17 cubic meters per hour or more, or about 1.7-8.5 cubic meters per hour, about 8.5-17 cubic meters per hour, or about 3.4-8.5 cubic meters per hour, or about 8.5-13.6 cubic meters per hour, or about 5.1-10.2 cubic meters per hour, or about 5.1-13.6 cubic meters per hour. The number of aerations/air replenishments between hold periods maybe around 1 or more, 2 or more, 3 or more, 4 or more, 5 or more, 4 or less, 3 or less, 2 or less, 1 or less, or 1-10, 1-5, 3-8, 2-4, or 1-2.

In some examples, any alkalizing agents and any cocoa materials may be combined in a reactor or chamber where the materials are mixed, e.g. under temperature and pressure and/or cycles of the same, and then may be subjected to additional treatments in the chamber(s) such as the addition of air or imposition of vacuum. For example, the materials may undergo mixing at a second elevated temperature for a hold period inside a reactor or chamber, which is then opened to allow aeration/cooling/depressurizing for an aeration period (e.g. 15 minutes or less) to an intermediate elevated temperature (lower than the second elevated temperature but higher than ambient) and then the reactor or chamber is closed to again raise the temperature/pressure for another hold period, all while mixing or other mechanical action is ongoing.

In some examples, the process includes drying the obtained mixture to provide an alkalized cocoa material. In some examples, the obtained, alkalized mixture may be dried, for example by air drying, hot air drying, vacuum drying, or combinations thereof. In some examples, the alkalized mixture may be dried multiple ways, e.g. some is air dried and some is vacuum dried, for example under reaching a desired moisture content such as about 10% or less, by weight, or about 7% or less, or about 5% or less. In some example, some or all of the mixture is dried by hot air, e.g. by blowing air at a temperature equal to the first and/or second elevated temperature. In some examples, the alkalized mixture is dried via vacuum drying for a period of about 15-75 minutes, or about 30-60 minutes.

As noted above, in some examples of the process, the process may include adding water to at least the cocoa (potentially with one or more alkalizing agents present and/or added later), and then mixing the water and at least the cocoa. For example, water may be added to a combination of cocoa and the first alkalization agent, or after both alkalization agents are added but before an initial hold period of processing. The water may be added at a selected elevated temperature, after already added ingredients have been heated to a desired level such as 85-115 degrees Celsius, or about 90-100 degrees Celsius, or about 120-150 degrees Celsius, e.g. during a ramp up to a desired elevated temperature later achieved, such as through the continued addition of steam. In some examples, the amount of water added is equal to about 20%, by weight, of the amount of cocoa material, e.g. if 1 kg of cocoa material is being alkalized, 200 grams of water is added. In some examples, the amount of water is equal to about 10%, by weight, of the amount of cocoa material, or about 15%, or about 20%, or about 25%, or about 30%, or about 35%, or about 40%, or about 45%, or about 50%, or about 60%, or about 70%, or about 10-60%, or about 20-40%, or about 30-50%, or about 10-25%, or about 50% or less, or about 40% or less, or about 30% or less, or about 20% or less, or about 10% or less, or about 10% or more, or about 15% or more, or about 20% or more, or about 30% or more, or about 50% or more. Water may be added to provide an overall moisture content, by weight of the overall mixture, of about 20% or more, 30% or more, 50% or more, 40% or less, 50% or less, or 20% or less, or about 10-60%, about 20-50%, about 10-40%, about 25-55%, about 20-30%, about 30-40%, or about 10-15%, or about 10-30%.

In some examples, the amount of the first alkalizing agent added is equal to about 1%, by weight, of the amount of cocoa material, e.g. if 1 kg of cocoa material is being alkalized, 10 grams of the first alkalizing agent (e.g. MgOH or NaOH) is added. In some examples, the amount of the first alkalizing agent is equal to about 2%, by weight, of the amount of cocoa material, or about 3%, or about 4%, or about 5%, or about 7%, or about 10%, or about 12%, or about 15%, or about 1-15%, or about 1-4%, or about 4-10%, or about 2-4%, or about 4-8%, or about 5-10% or about 4-20%, or about 5-18%, or about 7-14%, or about 15% or less, or about 10% or less, or about 8% or less, or about 4% or less, or about 3% or less, or about 2% or less, or about 1% or less, or about 1% or more, or about 2% or more, or about 3% or more, or about 5% or more, or about 8% or more.

In some examples, the amount of the second alkalizing agent added is equal to about 1%, by weight, of the amount of cocoa material, e.g. if 1 kg of cocoa material is being alkalized, 10 grams of the second alkalizing agent (e.g. calcium carbonate or ammonium carbonate or ammonium bicarbonate) is added. In some examples, the amount of the second alkalizing agent is equal to about 2%, by weight, of the amount of cocoa material, or about 3%, or about 4%, or about 5%, or about 7%, or about 10%, or about 12%, or about 15%, or about 1-15%, or about 1-4%, or about 4-10%, or about 2-4%, or about 4-8%, or about 15% or less, or about 10% or less, or about 8% or less, or about 4% or less, or about 3% or less, or about 2% or less, or about 1% or less, or about 1% or more, or about 2% or more, or about 3% or more, or about 5% or more, or about 8% or more. As shown above by the illustrative examples, the molar amounts of the alkalizing agents may different and the first agent may be present in a higher molar amount than the second, e.g. if the first agent is a hydroxide compound and the second agent is a carbonate compound, or vice versa, e.g. if the first agent is a carbonate compound and the second agent is a hydroxide compound.

The alkalizing agents may be added in solid or liquid form. If added in liquid form, the concentration of agents may be about 25% solution or about a 50% solution (with the active concentration used to determine the amount of agent to add, i.e. the diluent/water of the solution is not used when determining the amount of agent, by weight, that should be present), or about 25-75%, or about 25-50%, or about 15-40%. In some examples, the total amount of alkalizing agents is equal to about 1-20%, by weight, of the amount of cocoa material, or about 3-18%, or about 3-7%, or about 3-6%, or about 3-10%, or about 5-14%, or about 6-18%, or about 7-12%, or about 5-18%, or about 11-22%, or about 13-17% or about 8-10%, or about 18% or less, or about 15% or less, or about 14% or less, or about 12% or less, or about 10% or less, or about 8% or less, or about 7% or less, or about 6% or less, or about 5% or less, or about 4% or less, or about 4% or more, or about 5% or more, or about 7% or more, or about 9% or more, or about 12% or more. In some examples, the inventive processes surprisingly result in cocoa materials including cocoa cake that are alkalized to a dark cocoa material using a total amount of alkalizing agents less than 7% by weight (e.g. 6.9%). If a diluted liquid form is used, the amount of water added via the alkalizing agent(s) may be subtracted from the amount of additional water added to the reactor, if any.

In some examples, the ratio of the two alkalizing agents to each other are about equal, i.e. each provides about 50% of the total amount of alkali added, by weight, or in a ratio of about 45% to 55%, or a ratio of about 40% to 60%, or a ratio of about 35% to 65%, or a ratio of about 30% to 70%. In some examples, a third agent may be used, where amounts may be about equal or within about 10% of each other, based on the total amount of alkali added, e.g. all are within 23%-43% by weight of the total alkali and total 100%. In certain examples, an alkalizing agent including ammonium is present in a relatively smaller amount than an alkalizing agent that does not include ammonium. In certain examples, a hydroxide alkalizing agent is present in a higher amount, by weight, than the second agent. In other examples, an ammonium agent is present in a higher amount, by weight, than a hydroxide agent.

In some examples, no solvents are used in the preparation of the alkalized cocoa material. In some examples of the process, the process may include adding compressed air to the cocoa, the first alkalization agent, and the second alkalization agent after at least one hold period, for example to lower the temperature of the mixture, and/or to aerate the material(s), either at the end of the process and/or between hold periods, if multiple. As discussed herein, the procedures may involve adding cocoa, alkalizing agents, and water together, and mixing under heat for a hold period, then depressurizing/aerating the mixture while continuing to mix before repeating a higher temperature/pressurized hold period, such that cycles of hold periods and depressurized aeration may be used before final drying step(s) after the final hold period.

In some examples, the alkalized cocoa material may include a moisture content of about 1-20%, by weight, or about 10-50%, or about 20-40%, or about 10-30%, or about 20-50%, e.g. about 35% or less, about 25% or less about 15% or less, about 13% or less, about 10% or less, about 8% or less, about 5% or less, or about 3% or less, or about 1% or less, or about 3-7%, about 2-8%, about 8-14%, or about 8-18%, or about 6-14%. Moisture content is as determined by the oven drying method, ISO 2291. In certain examples, the alkalized material is dried via vacuum to a moisture content of about 8% or less, or about 5% or less. The vacuum process may not commence until the material is cooled below the final hold period elevated temperate, e.g. to a temperature of about 80-120 degrees Celsius, or about 100-115 degrees Celsius. The vacuum pressure may be about 22-36 mm Hg, or about 26-30 mm Hg, or about 30-36 mm Hg.

In certain examples, the cocoa being alkalized may include or entirely consist of cocoa cake. In certain examples, the cocoa being alkalized has a fat content of about 60% or less, about 30% or less, about 40% or less, about 30% or less, about 25% or less about 15% or less, about 12% or less, about 11% or less, or about 10% or less, or about 6-30%, about 8-25%, or about 5-30%, or about 8-24%, or about 10-16%, or about 8-15%, or about 7-25%, or about 8-14%, or about 10-13%. Fat content is as determined by the Soxhlet method, IOCCC Method NR.115-1990. In certain examples, the cocoa material being alkalized may have a moisture content of about 1-20%, by weight, before alkalization, about 15% or less, about 13% or less, about 10% or less, about 8% or less, about 5% or less, or about 3% or less, about 1-6%, about 2-5%, or about 1-10%.

In some examples, the alkalized cocoa material is a dark cocoa material. In some examples, the alkalized cocoa material is a dark cocoa material. The alkalized cocoa material may be water soluble. In some examples, the obtained material is ground or milled into smaller pieces, e.g. after any drying, for example may be made into ground alkalized cocoa powder.

As discussed and illustrated herein, these cake alkalization process can produce highly alkalized dark cocoa materials such as dark cocoa powders. Color may be measured using the following parameters: lightness (L), which is grey scale value or the light or dark aspect of a color, where the lower the L-value, the darker the cocoa powder will appear; chroma (C), which is the intensity of a color by which one distinguishes a bright or gray color, where the higher the C-value, the brighter the powder will be; and hue (h), which is referring to color in daily speech, such as red, yellow, or blue, where for cocoa products, a low H value indicates a red color and a high H-value indicates a brown color; the a* parameter represents the range from green to red, and the b* parameter, which represents the range from blue to yellow.

In certain examples, the alkalized cocoa material has color values in the following ranges. For intrinsic color analysis (methodology provided below), example compositions have an L value of about 0.2-6, a C value of about 0.5-6, and h value of about 35-45, an a* value of about 0.3-4.5, and a b* value of about 0.2-4.5. For white diluent color analysis (methodology provided below), example compositions have an L value of about 16-30, a C value of about 3-9, and h value of about 40-55, an a* value of about 2-6, and a b* value of about 1.5-8.

Color values are as measured by a Datacolor Spectraflash Color Spectrophotometer (models SF450X, 500, 700 or 800), with the following settings, Illuminant D65, standard observer 10°, color in L*a*b*C*h or L*C*h according to CIELAB, measuring geometry d/8, aperture plate LAV (30 mm illuminated, 26 mm measured), specular reflection excluded, and UV-FILTER 0%. After an initial calibration (confirmed by green tile measurement and/or a control sample with known color reference values, which is prepared and tested the same way as the test sample), a test cocoa sample is prepared and tested to obtain intrinsic color values. About 7.5 grams of test cocoa is added to 100 mL of water and stirred to remove lumps and ensure consistency, then another 50 mL of water is added and the suspension is pumped through a quartz flow cuvette while stirring and the color values are recorded using the spectrophotometer. For the white diluent color analysis values, the procedure is the same as the intrinsic color analysis described above, except that a calcium carbonate/water medium having a L value of 82-89 is prepared and used instead of pure water.

In some examples, the alkalized material at the end of the process may have a low ash content, such as about 12% or less (as determined by IOCCC Method 16) by weight, or about 11% or less, or about 10% or less, or about 9% or less, or about 8% or less, or about 8-12%, about 8-10%, or about 10-12%. In some examples, the alkalized material at the end of the process may have a low sodium content, such as about 20,000 mg/kg or less (as determined by NEN-EN 15510 ICP-AES method) or about 15,000 or less, or about 12,000 or less, or about 12,000-24,000, or about 10,000-12,000, or about 20,000-24,000. In some examples, the alkalized material at the end of the process may have a low acrylamide content, such as about 150 micrograms per kilogram or less (as determined by CHE587W-HPLC-MS/MS method) or about 100 or less, or about 50 or less, or about 30 or less.

In an example of the process, alkalized dark cocoa cake is made by mixing (e.g. chopping and plowing, with agitation at a speed of 50-170 revolutions per minute chopping at a speed of 1000-3500 revolutions per minute) cocoa cake and a first alkalization agent together at an initial temperature of 75-125 degrees Celsius, e.g. 90-110, then mixing and heating the cocoa cake and the first alkalization agent, e.g. a hydroxide material like sodium hydroxide, until reaching a first elevated mixing temperature of 75-150 degrees Celsius, e.g. 100-130 degrees, and an elevated pressure of about 2-8 bars, e.g. 4-8 bars or 6-8 bars, then adding a second alkalization agent, e.g. an ammonium material like ammonium carbonate or ammonium bicarbonate, to the cocoa cake and the first alkalization agent, and then adding water and mixing. The total amount of alkalizing material is about 15% or less, by weight, e.g. about 14.5%, about 12%, about 8%, or about 6.9%. In this example, the process then includes mixing and heating the materials until reaching a second elevated mixing temperature of 75-150 degrees Celsius, e.g. 120-150 degrees, and an elevated pressure of about 4-8 bars, e.g. 6-8 bars, and then mixing materials at the second elevated mixing temperature for at an initial hold period of 30-150 minutes in length, e.g. 90 minutes, or 60 minutes, to provide a mixture. In this example, the process then includes aerating and cooling the mixture, e.g. via an ambient aeration (but a pressurized aeration, e.g. using about 5.1-10.2 cubic meters per hour of air and a maximum pressure of 4-6 bar, is also possible), and then heating the mixture to a third elevated mixing temperature of 75-150 degrees Celsius, e.g. 120-150 degrees, and an elevated pressure of about 4-8 bars, e.g. 6-8 bars, and mixing for at least one additional hold period of 30-150 minutes in length, e.g. 20 minutes each, e.g. two additional hold periods or three additional hold periods (with cooling/depressurizing/aerating in between additional hold periods). In this example, the pressure is increased by adding steam. The mixture was then dried with vacuum drying, until then alkalized cocoa material has a moisture content of 1-20%, by weight, e.g. 5-15%. The resulting product may have a moisture content of less than 10%, e.g. 4-8%. The resulting product may have an ash content of about 15% or less, e.g. about 8-12%. The resulting product may have a sodium content of about 25,000 mg/kg or less, e.g. about 10,000-20,000 or about 10,000-12,000. The resulting product may have a potassium content of about 25,000 mg/kg or less. The resulting product may have an acrylamide content of about 150 micrograms/kg or less, e.g. less than 30 micrograms/kg. The resulting product may have, for intrinsic color analysis, an L value of about 0.2-6, a C value of about 0.5-6, and H value of about 35-45, an A value of about 0.3-4.5, and a B value of about 0.2-4.5., and for white diluent color analysis, an L value of about 16-30, a C value of about 3-9, and H value of about 40-55, an A value of about 2-6, and a B value of about 1.5-8.

In an example of the process, dark alkalized cocoa cake is made by mixing (e.g. chopping and plowing, with agitation at a speed of 50-170 revolutions per minute and chopping at a speed of 1000-3500 revolutions per minute) cocoa cake, a first alkalization agent, e.g. a hydroxide material like sodium hydroxide, and a second alkalization agent, e.g. an ammonium material like ammonium carbonate or ammonium bicarbonate, and then adding water and mixing. The total amount of alkalizing material is about 15% or less, by weight, e.g. about 14.5%, about 12%, about 8%, or about 6.9%. In this example, the process then includes mixing and heating the materials until reaching a first elevated mixing temperature of 75-150 degrees Celsius, e.g. 120-150 degrees, and an elevated pressure of about 4-8 bars, e.g. 6-8 bars, and then mixing materials at the second elevated mixing temperature for at an initial hold period of 30-150 minutes in length, e.g. 90 minutes, or 60 minutes, to provide a mixture. In this example, the process then includes aerating and cooling the mixture, e.g. via an ambient aeration (but a pressurized aeration, e.g. using about 5.1-10.2 cubic meters per hour of air and a maximum pressure of 4-6 bar, is also possible), and then heating the mixture to a third elevated mixing temperature of 75-150 degrees Celsius, e.g. 120-150 degrees, and an elevated pressure of about 4-8 bars, e.g. 6-8 bars, and mixing for at least one additional hold period of 30-150 minutes in length, e.g. 20 minutes each, e.g. two additional hold periods or three additional hold periods (with cooling/depressurizing/aerating in between additional hold periods). In this example, the pressure is increased by adding steam. The mixture was then dried with vacuum drying, until then alkalized cocoa material has a moisture content of 1-20%, by weight, e.g. 5-15%. The resulting product may have a moisture content of less than 10%, e.g. 4-8%. The resulting product may have an ash content of about 15% or less, e.g. about 8-12%. The resulting product may have a sodium content of about 25,000 mg/kg or less, e.g. about 10,000-20,000 or about 10,000-12,000. The resulting product may have a potassium content of about 25,000 mg/kg or less. The resulting product may have an acrylamide content of about 150 micrograms/kg or less, e.g. less than 30 micrograms/kg. The resulting product may have, for intrinsic color analysis, an L value of about 0.2-6, a C value of about 0.5-6, and H value of about 35-45, an A value of about 0.3-4.5, and a B value of about 0.2-4.5., and for white diluent color analysis, an L value of about 16-30, a C value of about 3-9, and H value of about 40-55, an A value of about 2-6, and a B value of about 1.5-8.

According to another embodiment, the present disclosure relates to the processes, wherein the produced alkalized cocoa material has a dark (dark brown or even black) colour based as determined by the white diluent method described herein, for example where L is between about 16 to 30, or about 17 to 25, or about 18 to 22, where a* is between about 1 to 7, or about 2 to 6, or about 3 to 5, and where b* is between about 1 to 10, or about 1.5 to 8, or about 2 to 7, as determined by spectrophotometer as described above (i.e. via Datacolor Spectraflash color spectrophotometer according to the Datacolor DC series user guide using settings Illuminant D65, standard observer 10°, geometry d/8°, aperture plate LAV (30 mm illuminated, 26 mm measured)). In some processes, the produced alkalized cocoa material has a dark (dark brown or even black) colour based as determined by the instrinsic color analysis method described herein, method described herein, for example where L is between about 0.2 to 6, or about 0.2 to 4, or about 0.2 to 2, or about 1-4, or about 2-6, where a* is between about 0.3 to 4.5, or about 1 to 4, or about 2 to 3, or about 0.3 to 2, and where b* is between about 0.2 to 4.5, or about 1 to 4, or about 2 to 3, or about 0.2 to 2. The CIELAB values of cocoa powder can be used for quality control to ensure consistency in the color of their cocoa powder products across batches and for food scientists and product developers to adjust the color of cocoa powder formulations to meet specific requirements or to match the color of existing products improving product's appearance. Specifically, the L value represents the lightness or darkness of the cocoa powder, with 0 being black and 100 being white. The a* and b* values represent the color components along the green-red and blue-yellow axes, respectively.

In some examples, the total amount of alkalization agent in the first mixture is between 6 to 18 wt %, between 7 to 16 wt %, between 8 to 15 wt %, or between 10 to 14 wt %, based on the total weight of the first mixture. In some examples, the at least one additional hold period comprises between one to five additional hold periods, e.g. two to four additional hold periods. In certain examples, the first hold period is 75 to 90 minutes in length and the at least one additional hold period is shorter than the first hold period. In certain examples, aeration results in cooling of the first mixture or further mixture to a temperature below the elevated mixing temperature, e.g. to a temperature of 1 to 50° C., or 5 to 25° C., or 10 to 15° C. below the elevated mixing temperature. In some examples, aeration is done at an air flow rate of about 1.61 to 16.05 m3/hr, or 3.21 to 12.84 m3/hr, or 4.82 to 9.63 m3/hr, or 6.42 to 8.03 m3/hr. In certain examples, the cocoa raw material is one or more selected from the group consisting of cocoa beans, cocoa nibs, cocoa butter, cocoa cake, cocoa powder, cocoa liquor, and any source that comprises cocoa solids, such as cocoa powder, cocoa liquor or cocoa cake. In certain examples, the total length of the hold periods in the process is between about 20 to 400 minutes, 60 to 380 minutes, 120 to 350 minutes, or 150 to 320 minutes. In some examples, the moisture content of the cocoa raw material is between about 15 to 60 wt %, 20 to 50 wt %, or 25 to 40 wt %, based on the total weight of the cocoa raw material.

In some examples, the cocoa raw material has a fat content of between about 6 to 55 wt %, 8 to 24 wt %, 10 to 20 wt %, or 12 to 18 wt %, based on the total weight of the cocoa raw material. In certain examples, water is added to the cocoa raw material, the first alkalization agent and the second alkalization agent when reaching a temperature during heating of about 80 to 105° C., 85 to 95, or 87 to 90° C. In certain examples, the first alkalization agent and the second alkalization agent each comprise or consist of one or more hydroxide materials, one or more bicarbonate materials, one or more carbonate materials, or combinations thereof, and where the first alkalization agent and the second alkalization agent are the same or are different. In some examples, the first alkalization agent and the second alkalization agent each comprise or consist of sodium hydroxide or ammonium carbonate or ammonium bicarbonate or potassium carbonate. In some examples, the first alkalization agent and the second alkalization agent each comprise or consist of magnesium hydroxide, sodium hydroxide, calcium hydroxide, magnesium oxide, sodium carbonate, potassium carbonate, ammonium carbonate or ammonium bicarbonate, calcium carbonate, or combinations thereof.

In some examples of the process, any mixing comprises agitating the materials being mixed, chopping the materials being mixed, or both, and where any agitation is at a speed of about 50-170 revolutions per minute (rpm), 65 to 150 rpm, or 70 to 100 rpm, and/or wherein any chopping is at a speed of 1000-3500 rpm, 1400 to 2500 rpm, or 1700 to 2000 rpm. In some examples, the elevated pressure is generated by the addition of heated air, steam, or a combination thereof, and in some examples the mixture is dried by air drying, hot air drying, vacuum drying, or combinations thereof. In some examples, any aeration is done by adding compressed air to the reactor. In some examples, any aeration is performed at an ambient pressure, e.g. at an atmospheric pressure of about 1 bar. In some examples, any aeration of the first mixture is performed at an elevated pressure of about 2 to 10 bara, 3 to 8 bara, or 4 to 6 bara.

The disclosure also relates to an alkalized cocoa material obtained via or obtainable by a process of the present disclosure. In some examples, the alkalized cocoa material has a fat content of 6 to 30 wt %, 7 to 25 wt %, 8 to 18 wt %, or 10 to 15 wt %, based on the total weight of the cocoa material. In some examples, the alkalized cocoa material has a Na content of 9000 to 24000 mg/kg of the cocoa material, 10000 to 20000 mg/kg, 12500 to 18000 mg/kg, or 15000 to 17500 mg/kg. In some example, the alkalized cocoa material has a K content of 19000 to 24000 mg/kg of the cocoa material, 20000 to 23000 mg/kg, or 21000 to 22000 mg/kg. In some examples. The alkalized cocoa material has an ash content of 5 to 18 wt %, 7 to 16 wt %, 8 to 14 wt %, or 10 to 12 wt %, based on the total weight of the cocoa material. In some examples, the alkalized cocoa material has an acrylamide content of at most 300 μg/kg of the cocoa material, at most 200 μg/kg, at most 150 μg/kg, at most 90 μg/kg, most or at most 30 μg/kg. In certain embodiments, the alkalized cocoa material has a dark color as based on a white diluent color analysis, wherein L is between 16 to 30, 17 to 25, 18 to 22, C is 5 to 9, 5.5 to 8, 6 to 7.5, and h is between 40 to 52, 42 to 50, or 44 to 48, as determined by spectrophotometer. In some examples, the alkalized cocoa material has a pH of between 6.0 to 8.5, between 6.2 to 8.2, between 6.5 to 7.8, or between 6.8 to 7.5.

In another aspect of the disclosure, edible compositions such as cookies or other desserts are provided. Example edible compositions include cookies, cakes, breads, beverages, ice cream, pies, or truffles. In some examples, an edible composition includes an alkalized cocoa material made from a process of this disclosure, such as a dark cocoa material. Edible compositions may include alkalized cocoa material with any of the property characteristics discussed herein, including the properties identified in Tables 1-4 below. E.g. a cookie may include a dark alkalized cocoa powder with an intrinsic color L value between 0.2-6. In other examples, an edible composition includes two or more alkalized cocoa materials, each made from distinct processes of this disclosure.

Compositions made from the methods of this disclosed may have the following properties provided across Tables 1-3.

TABLE 1
Intrinsic Color Analysis

| | L | C | h | a* | b* |
|---|---|---|---|---|---|
| Minimum | 0.2 | 0.5 | 35 | 0.3 | 0.2 |
| Maximum | 6 | 6 | 45 | 4.5 | 4.5 |

TABLE 2
White Diluent Color Analysis

| | L | C | h | a* | b* |
|---|---|---|---|---|---|
| Minimum | 16 | 3 | 40 | 2 | 1.5 |
| Maximum | 30 | 9 | 55 | 6 | 8 |

TABLE 3
Other Properties

| | Fat Content | | Na | K | Ash | Acrylamide |
|---|---|---|---|---|---|---|
| | (%) | pH | (mg/kg) | (mg/kg) | (%) | (%) |
| Minimum | 8 | 6.3 | 9,000 | 20,000 | 7.0 | <30 |
| Maximum | 24 | 8.25 | 24,000 | 23,000 | 16 | 300 |

### EXAMPLES

Example processes are below to further illustrate the content of this disclosure.

In a first example, about 10 kg of cocoa nibs and about 1 kg of potassium hydroxide are combined and mixed together for about five minutes, where the agitator is operated at about 165 rpm and the chopper is operating at about 3300 rpm (in each example these mixing parameters for agitation/chopping are the same throughout the entire process until completion, but in other embodiments parameters may vary, for example agitation/chopping may increase/decrease), and then about 5 kg of water is added. The mixture is heated, until reaching a temperature of about 110 degrees Celsius. Then about 0.25 kg of sodium hydroxide is added to the mixture. The mixture is then heated until reaching a temperature of about 150 degrees Celsius and a pressure of about 5 bars. The components are then mixed under these conditions for about 75 minutes. The reactor is then opened and the obtained mixture is dried via vacuum drying.

In a second example, about 10 kg of cocoa cake and about 0.3 kg of sodium hydroxide are combined and mixed together for about one minute, where the agitator is operated at about 52 rpm and the chopper is operating at about 1145 rpm, and then about 4 kg of water is added. The mixture is heated by addition of steam, until reaching a temperature of about 140 degrees Celsius. Then about 0.6 kg of calcium carbonate is added to the mixture. The mixture is then heated until reaching a temperature of about 180 degrees Celsius and a pressure of about 6 bars. The components are then mixed under these conditions for about 110 minutes. The reactor is then opened and the obtained mixture is dried via air drying with heated blown air at a temperature of about 140 degrees Celsius.

In a third example, about 10 kg of cocoa powder and about 0.9 kg of calcium hydroxide are combined and mixed together for about one minute, where the agitator is operated at about 95 rpm and the chopper is operating at about 2200 rpm, and then about 7 kg of water is added. The mixture is heated by addition of steam, until reaching a temperature of about 75 degrees Celsius. Then about 0.5 kg of ammonium carbonate is added to the mixture. The mixture is then heated until reaching a temperature of about 115 degrees Celsius and a pressure of about 2 bars. The components are then mixed under these conditions for about 75 minutes. The reactor is then opened and the mixture is aerated using about 8.5 cubic meters per hour blown air for one minute. Then the reactor is sealed and the mixture undergoes a similar second, additional heated and pressurized mixing cycle (without the pause for alkalizing material addition, i.e. a ramp back to a temperature of about 115 degrees Celsius and a pressure of about 2 bars before mixing during the hold period) for a hold period of about 200 minutes. The reactor is then opened and the obtained mixture is dried via vacuum drying.

In a fourth example, about 10 kg of cocoa nibs and about 0.1 kg of sodium hydroxide are combined and mixed together for about one minute, where the agitator is operated at about 125 rpm and the chopper is operating at about 3000 rpm, and then about 2 kg of water is added. The mixture is heated by addition of steam, until reaching a temperature of about 105 degrees Celsius. Then about 0.8 kg of sodium bicarbonate is added to the mixture. The mixture is then heated until reaching a temperature of about 145 degrees Celsius and a pressure of about 4 bars. The components are then mixed under these conditions for about 180 minutes. The reactor is then opened and the mixture is aerated using about 1.7 cubic meters per hour blown air for about two minutes. Then the reactor is sealed and the mixture undergoes five additional heated and pressurized mixing cycles (with intervening aeration), each additional period lasting for a hold period of 10 minutes. The reactor is then opened and the obtained mixture is dried via vacuum drying.

In a fifth example, about 10 kg of cocoa cake and about 0.4 kg of sodium hydroxide are combined and mixed together for about two minutes, where the agitator is operated at about 80 rpm and the chopper is operating at about 1800 rpm, and then about 3 kg of water is added. The mixture is heated by the application of steam until reaching a temperature of about 90 degrees Celsius. Then about 0.25 kg of ammonium carbonate is added to the mixture and the reactor is closed. The mixture is then heated by the application of steam until reaching a temperature of about 130 degrees Celsius and a pressure of about 4 bars. The components are then mixed under these conditions for about 90 minutes. The reactor is then opened and the mixture is aerated using about 3.4 cubic meters per hour blown air for about 5 minutes. Then the reactor is sealed and the mixture undergoes three additional similar heated and pressurized mixing cycles (with intervening aeration) where each of the three additional hold periods was about 55 minutes long. Then mixture is then cooled and dried via vacuum drying.

In a sixth example, about 10 kg of cocoa cake and about 1.2 kg of calcium hydroxide are combined and mixed together for about ten minutes, where the agitator is operated at about 120 rpm and the chopper is operating at about 2550 rpm, and then about 8 kg of water is added. The mixture is heated by the application of steam until reaching a temperature of about 65 degrees Celsius. Then about 1 kg potassium hydroxide is added to the mixture and the reactor is closed. The mixture is then heated by the application of steam until reaching a temperature of about 105 degrees Celsius and a pressure of about 5 bars, where additional air is added to reach the desired pressure. The components are then mixed under these conditions for about 25 minutes. The reactor is then opened and the mixture is aerated using about 0.8 cubic meters per hour blown air for about 7 minutes. Then the reactor is sealed and the mixture undergoes an additional six heated and pressurized mixing cycles (with intervening aeration) where each additional cycle had a hold period of about 40 minutes. Then mixture is then cooled by ambient air drying.

In a seventh example, about 10 kg of cocoa cake and about 0.2 kg of sodium bicarbonate are combined and mixed together for about 1.5 minutes, where the agitator is operated at about 65 rpm and the chopper is operating at about 3300 rpm, and then about 4 kg of water is added. The mixture is heated until reaching a temperature of about 85 degrees Celsius. Then about 1 kg of calcium hydroxide is added to the mixture and the reactor is closed. The mixture is then heated by the application of steam until reaching a temperature of about 115 degrees Celsius and a pressure of about 3 bar. The components are then mixed under these conditions for about 135 minutes. The reactor is then opened and the mixture is aerated using about 5.9 cubic meters per hour blown air for 5 minutes. Then mixture is then dried via vacuum drying.

In an eighth example, about 10 kg of cocoa nibs and about 0.65 kg of sodium hydroxide are combined and mixed together for about three minutes, where the agitator is operated at about 150 rpm and the chopper is operating at about 3100 rpm, and then about 5.5 kg of water is added. The mixture is heated until reaching a temperature of about 80 degrees Celsius. Then about 0.5 kg of sodium carbonate is added to the mixture and the reactor is closed. The mixture is then heated by the application of steam until reaching a temperature of about 145 degrees Celsius and a pressure of about 4.5 bars. The components are then mixed under these conditions for about 115 minutes. The reactor is then opened and equilibrates to ambient conditions. Then the reactor is sealed and the mixture undergoes one additional heated and pressurized mixing cycle where the additional cycle has a hold period time of about 30 minutes. The obtained mixture is then cooled and dried via ambient air drying.

In a ninth example, about 10 kg of cocoa nibs and about 1.5 kg of potassium hydroxide are combined and mixed together for about two minutes, where the agitator is operated at about 90 rpm and the chopper is operating at about 2300 rpm, and then about 3.4 kg of water is added. The mixture is heated via steam until reaching a temperature of about 100 degrees Celsius. Then about 0.1 kg ammonium carbonate is added to the mixture and the reactor is closed. The mixture is then heated by the application of steam until reaching a temperature of about 160 degrees Celsius and a pressure of about 6 bars, with additional air added to increase pressure. The components are then mixed under these conditions for about 30 minutes. The reactor is then opened and the mixture is aerated using about 4.2 cubic meters per hour blown air for about 4 minutes. Then the reactor is sealed and the mixture undergoes an additional four heated and pressurized mixing cycles (with intervening aeration) where each additional cycle has a hold time of about 30 minutes. Then the obtained mixture is dried by blown, heated air.

In a tenth example, about 10 kg of cocoa nibs and about 1.5 kg of ammonium carbonate are combined and mixed together for about 30 seconds, where the agitator is operated at about 135 rpm and the chopper is operating at about 3400 rpm, and then about 3.25 kg of water is added. The mixture is heated, by the application of steam until reaching a temperature of about 130 degrees Celsius. Then about 0.15 kg of calcium ammonium carbonate is added to the mixture and the reactor is closed. The mixture is then heated by the application of steam until reaching a temperature of about 140 degrees Celsius and a pressure of about 6.5. The components are then mixed under these conditions for about 240 minutes. The reactor is then opened and the mixture is aerated using about 5.1 cubic meters per hour blown air for about one minute. Then the reactor is sealed and the mixture undergoes one additional, similar heated and pressurized mixing cycles where the additional cycle has a hold period of about 90 minutes. Then mixture is then dried via air drying.

In additional to the above ten examples (all prophetic) that detail a range potential values and conditions for example embodiments of this disclosure, the below related examples are provided to further assist with illustration of the disclosure, where these examples re-use certain illustrative values, e.g. type and amount of cocoa material, amount and type of alkalizing agents added, and certain processing conditions, to more simply illustrate embodiments of the process and/or resulting compositions. The invention is not limited to these examples, materials, or conditions, which are illustrative.

In an eleventh, working, example, about 90 kg of cocoa cake (11% fat) was combined with about 3.8 kg sodium hydroxide and about 2.5 kg ammonium bicarbonate. The materials were combined and mixed (plow speed 70 rpm and chopper speed 1740 rpm) while steam was applied to the reactor jacket until reaching a temperature of 90 degrees Celsius, at which point mixing was increased (105 rpm for plow and 2610 rpm for chopper) about 27 kg of water was added via injection using the pressure pot. The mixture was heated by the application of steam until reaching a mixture temperature of about 130 degrees Celsius, and a pressure of about 5 bar, where the reactor was completely sealed. The components were then mixed under these conditions for about 90 minutes, where the pressure increased as the reaction proceeded, and the reactor in this stage was set to have a maximum pressure of about 6 bar and to drop to about 5.5 bar if a reduction in pressure was needed. The reactor was then opened and the mixture was aerated using about 5.1 cubic meters per hour blown air for about five minutes to cool the mixture and replenish air. Then the reactor was sealed and the mixture underwent three additional, similar heated and pressurized mixing cycles where the additional cycles each had a hold period of about 20 minutes. Then mixture was then dried via vacuum drying for 60 minutes. Total holding time in the process (product residence time at held elevated temperature/pressure in sealed reactor) was about 150 minutes. Property information for the prepared material is provided in the table below.

In a twelfth, working, example, about 90 kg of cocoa cake (11.1% fat) was combined with about 1.73 kg sodium hydroxide and about 1.13 was ammonium bicarbonate. The materials were combined and mixed (plow speed 105 rpm and chopper speed 3480 rpm) while steam was applied to the reactor jacket until reaching a temperature of 90 degrees Celsius, at which point about 27 kg of water was added via injection using the pressure pot. The mixture was heated by the application of steam until reaching a mixture temperature of about 130 degrees Celsius, and a pressure of about 4 bar, where the reactor was completely sealed. The components were then mixed under these conditions for about 90 minutes, where the pressure increased as the reaction proceeded, and the reactor in this stage was set to have a maximum pressure of about 6 bar and to drop to about 5.5 bar if a reduction in pressure was needed. The reactor was then opened, vented for a few minutes, and then aerated using a pressurized aeration, with a closed/appropriately vented reactor heated to about 130 degrees Celsius using about 5.1 cubic meters per hour blown air to provide a pressure of about 5 bar, with these conditions held for about 60 minutes. The mixture then underwent three additional, heated and pressurized mixing hold cycles under similar conditions as the initial 90 minute hold period, with each additional hold in the fully sealed reactor totaling 60 minutes. The mixture was then dried via vacuum drying for 15 minutes. The total holding time in the process was about 270 minutes. Property information for the prepared material is provided in the table below.

In a related, thirteenth example (prophetic), the twelfth example is repeated, but the first hold period is thirty minutes in length and, prior to vacuum drying but after the pressurized aeration, the reactor is opened/depressurized, then re-sealed and the mixture undergoes 2 additional, similar heated and pressurized mixing cycles under conditions of the first hold period, where the additional cycles each have a hold period of about 30 minutes.

In fourteenth example (prophetic), about 90 kg of cocoa cake (11% fat) is combined with a total amount of alkalizing agents equivalent to 6.9% wt. of the cocoa material, where 60% of the total alkalizing agent amount is sodium hydroxide and 40% is ammonium carbonate. The materials are combined and mixed (plow speed 113 rpm and chopper speed 3480 rpm) while steam is applied to the reactor jacket until reaching a temperature of 90 degrees Celsius, at which point about 27 kg of water is added via injection using the pressure pot. The mixture is heated by the application of steam until reaching a mixture temperature of about 150 degrees Celsius, and a pressure of about 5 bar, where the reactor is completely sealed. The components are then mixed under these conditions for about 90 minutes, where the pressure increases as the reaction proceeded, and the reactor in this stage is set to have a maximum pressure of about 8 bar and to drop to about 7.5 bar if a reduction in pressure was needed. The reactor is then opened and the mixture is aerated using about 10.2 cubic meters per hour blown air for about five minutes to cool the mixture and replenish air, and is then further aerated using a pressurized aeration, with a closed/appropriately vented reactor heated to about 125 degrees Celsius using about 10.2 cubic meters per hour blown air to provide a pressure of about 8 bar, with these conditions held for about 90 minutes. The mixture is then dried via vacuum drying for 30 minutes.

In a fifteenth example (prophetic), the fourteenth example is repeated, but prior to vacuum drying, and after the pressurized aeration, the reactor is opened/depressurized, then re-sealed and the mixture undergoes one additional, similar heated and pressurized mixing cycle under conditions of the first hold period, where the additional cycle has a hold period of about 45 minutes.

In a reference example 1, 3,500 kg of cocoa powder was added to a horizontal reactor, without chopping, and about 105 kg of ammonium bicarbonate and about 98 kg of sodium hydroxide were combined at ambient temperature and atmospheric pressure, heated to about 90 degrees Celsius, and about 1,225 kg of water was added. The mixture was heated to a temperature of about 115 degrees, and a stirrer was operated at about 125 rpm. Then direct steam injection was used to bring the product temperature to 110-120° C. and reactor inner pressure at 1.6 bar. The mixture was kept for 90 minutes of the conditions where the materials were at 110-120 degrees Celsius and under a pressure of 1.4-1.6 bar. Then the reactor was opened, pressure was released to atmospheric pressure in 15 minutes, further cooled with blown air for 180 minutes, and the obtained mixture was dried via vacuum drying. The material had a pH of 8.2, a final fat content of 10.5, a final moisture content of 2.8%,intrinsic color values of L=10.1, C=4.4, h=21.1, a*=4.1, and b*=1.6, and white diluent color analysis values of L=38.7, C=20.0, h=52.1, a*=12.3, and b*=15.8.

In a reference example 2, about 3,500 kg of cocoa powder (10.9% fat content) and about 225 kg of ammonium bicarbonate and about 200 kg of sodium hydroxide were combined and charged to a reactor, where they were mixed, heated to about 90° C., and then about 1,250 kg of water was added. The mixture was heated, until reaching a temperature of about 120 degrees Celsius and pressure of about 3.5 bar. After venting, the mixture was kept at a temperature of about 125-130 degrees Celsius and the pressure fell from about 3.5 to 2.4 bar from venting during the mixing during the cycle, where mixing was maintained under these conditions for 60 minutes. Next, reactor was depressurized, opening the chimney valve from 0% to 100% in 10 minutes. Product temperature fell down from 133 degrees Celsius to 111 degrees Celsius and pressure dropped from 2.4 bar to 1.1 bar. Next, the temperature/pressure cycle was repeated 3 times, with 60 minutes of reaction at a temperatures of about 135 degrees Celsius and a pressure of about 3.4 bar for each 60 minute cycle. Then the reactor was opened and the obtained mixture was dried via vacuum drying. The total process time was 702 minutes. The material had a pH of 8.3, a moisture content of 4.2%, a fat content of 10.0%, intrinsic color values of L=4.1, C=5.5, h=34.2, a*=4.5, and b*=3.1, and white diluent color analysis values of L=26.4, C=12.2, h=49.5, a*=7.9, and b*=9.2.

The below table illustrates values from the example materials made from the eleventh and twelfth examples and comparative data from the reference examples.

TABLE 4

| | | | | | Reference | Reference |
|---|---|---|---|---|---|---|
| | Example 11 | | Example 12 | | Example 1 | Example 2 |
| Moisture | 6.2% | wt | 3.8% | wt | 2.8% | 4.2% wt |
| Content | | | | | | |
| Fat Content | 9.0% | wt | 11.1% | wt | 10.5% | 10.0% |
| Sodium | 23,000 mg/kg | | 11,000 | mg/kg | — | — |
| Content | | | | | | |
| Potassium | 21,000 | | 22,000 | mg/kg | — | — |
| Content | | | | | | |
| Ash Content | 10.9% | wt | 8.6% | wt | — | — |

| | | | | |
|---|---|---|---|---|
| Acrylamide | Less than | 149 ugrams/kg | — | — |
| Content | 30 ugrams/kg | | | |
| pH | 7.4 | 6.1 | 8.2 | 8.3 |
| L (intrinsic) | 2.4 | 2.5 | 10.1 | 4.1 |
| C (intrinsic) | 1.6 | 2.5 | 4.4 | 5.5 |
| h (intrinsic) | 40.4 | 38.4 | 21.1 | 34.2 |
| L (white | 21.6 | 21.4 | 38.7 | 26.4 |
| diluent) | | | | |
| C (white | 6.8 | 7.0 | 20.0 | 12.2 |
| diluent) | | | | |
| h (white | 47.6 | 46.3 | 52.1 | 49.5 |
| diluent) | | | | |

These materials, systems and process descriptions are merely examples. In certain embodiments, the processes include additional combinations and/or substitutions of some or all of steps and/or use of the components or conditions described above. Moreover, additional and alternative suitable variations, forms and steps will be recognized by those skilled in the art given the benefit of this disclosure. Finally, any of the features discussed in the example embodiments of the processes and/or systems may be features of embodiments of the resulting materials, and vice versa.

What is claimed is:

1. A multi-stage process for forming an alkalized cocoa cake material comprising the steps of:
mixing cocoa cake and a first alkalization agent together at an initial temperature, the cocoa cake comprising a fat content of 8-24%, by weight, and a moisture content of 1-7%, by weight;
mixing and heating the cocoa cake and the first alkalization agent until reaching a first elevated mixing temperature;
adding a second alkalization agent to the cocoa cake and the first alkalization agent;
mixing and heating the cocoa cake, the first alkalization agent, and the second alkalization agent through the applications of external heat until reaching a second elevated mixing temperature;
mixing the cocoa, the first alkalization agent, and the second alkalization agent at the second elevated mixing temperature for at an initial hold period to provide a mixture;
aerating and cooling the mixture;
heating the mixture to a third elevated mixing temperature and mixing for at least one additional hold period; and
drying the mixture to provide an alkalized cocoa material;
wherein all of the elevated mixing temperatures are 75-150 degrees Celsius;
wherein any hold periods are 10-150 minutes in length, and wherein a total residence time of the hold periods is 100-350 minutes;
wherein the mixture is aerated and cooled between any of the at least one additional hold periods; and
wherein water is added to at least the cocoa cake and mixed with at least the cocoa cake prior to the initial hold period.

2. The process of claim 1, wherein the first alkalization agent and the second alkalization agent each comprise or consist of one or more hydroxide materials, one or more bicarbonate materials, one or more carbonate materials, one or more alkaline oxide materials, or combinations thereof.

3. The process of claim 2, wherein the first alkalization agent and the second alkalization agent each comprise or consist of magnesium hydroxide, sodium hydroxide, calcium hydroxide, sodium carbonate, potassium carbonate, ammonium carbonate, ammonium bicarbonate, calcium carbonate, magnesium oxide, or combinations thereof.

4. The process of claim 1, wherein any mixing comprises agitating the materials being mixed, chopping the materials being mixed, or both.

5. The process of claim 1, wherein the first alkalization agent and the second alkalization agent are each solid alkalization agent or a liquid alkalization agent with a concentration of 25-75%, by weight, of the active alkalization agent.

6. The process of claim 1, wherein the first alkalization agent and the second alkalization agent each comprise or consist of sodium hydroxide, ammonium bicarbonate, ammonium carbonate, or ammonium hydroxide.

7. The process of claim 1, wherein the at least one additional hold period includes at least two additional hold periods, and wherein the mixture is cooled and aerated between the additional hold periods.

8. The process of claim 1, wherein the at least one additional hold period includes at least three additional hold periods, and wherein the mixture is cooled and aerated between the additional hold periods.

9. The process of claim 1, wherein the cocoa, the first alkalization agent, and the second alkalization agent are subjected to an elevated pressure above 2 bars during the initial hold period and the at least one additional hold period.

10. The process of claim 8, wherein the cocoa, the first alkalization agent, and the second alkalization agent are subjected to an elevated pressure of up to 8 bars during the initial hold period and the at least one additional hold period.

11. The process of claim 10, wherein the pressure is generated by the addition of heated air, steam, or a combination thereof.

12. The process of claim 1, wherein the mixture is dried by air drying, hot air drying, vacuum drying, or combinations thereof.

13. The process of claim 1, further comprising adding compressed air to the cocoa, the first alkalization agent, and the second alkalization agent after at least one additional hold period to lower the temperature of the mixture.

14. The process of claim 1, wherein the total amount of the first and second alkalization agents is equal to 3-18%, by weight, of the amount of cocoa material.

15. The process of claim 1, wherein the alkalized cocoa material comprises a moisture content of 1-20%, by weight.

16. The process of claim 1, wherein any aeration is performed at an ambient pressure.

17. The process of claim 1, wherein at least some aeration is performed at an elevated pressure.

18. A multi-stage process for forming an alkalized cocoa material comprising the steps of:
mixing and heating cocoa cake, a first alkalization agent, a second alkalization agent and water at a first elevated mixing temperature for at an initial hold period to provide a mixture;
aerating the mixture;
heating the mixture to a second elevated mixing temperature through the applications of external heat and mixing for at least one additional hold period; and
drying the mixture to provide an alkalized cocoa material;
wherein all of the elevated mixing temperatures are 75-150 degrees Celsius;
wherein the cocoa cake, the first alkalization agent, and the second alkalization agent are subjected to an elevated pressure above 2 bars during the initial hold period and the at least one additional hold period;
wherein any hold periods are 10-150 minutes in length, and wherein a total residence time of the hold periods is 100-350 minutes; and
wherein the mixture is aerated between any of the at least one additional hold periods.

19. The process of claim 18, wherein at least some aeration is performed at an elevated pressure.

20. An edible composition comprising an alkalized cocoa material made from the process of claim 18.
